(19) United States
(12) Patent Application Publication
(10) Pub. No.: US 2025/0340470 A1
(43) Pub. Date: Nov. 6, 2025

(54) COMPOSITION USEFUL IN SULFATE SCALE REMOVAL

(71) Applicant: DORF KETAL CHEMICALS FZE, Fujairah (AE)

(72) Inventors: Elsayed ABDELFATAH, Calgary (CA); Markus WEISSENBERGER, Calgary (CA)

(21) Appl. No.: 19/111,195

(22) PCT Filed: Sep. 19, 2023
(86) PCT No.: PCT/IB2023/059274

§ 371 Date: Mar. 12, 2025

(30) Foreign Application Priority Data
Sep. 30, 2022 (CA) 3178243

(51) Int. Cl. C02F 5/12; C02F 101/32

(52) U.S. Cl. CPC C02F 5/12; C02F 2101/32; C02F 2305/04

(57) ABSTRACT

An aqueous caustic composition comprising an emulsion for use in removing petroleum-contaminated barium sulfate scale from a surface contaminated with such, said composition comprising: a chelating agent and a counterion component selected from the group consisting of: Li₅DTPA; Na₅DTPA; K₅DTPA; Cs₅DTPA; Na₄EDTA; K₄EDTA; TEAH₄DTPA; and TBAH₄DTPA; a scale removal enhancer; a non-ionic surfactant; and said emulsion comprising: water; optionally, a hydrotrope; optionally, 3-Methoxy-3-methyl-1-butanol (MMB) or isopropanol; an alkanolamine; a surfactant selected from a group consisting of: a sulfonate surfactant; an alcohol ethoxylate surfactant; and a combination thereof; a non-ionic surfactant; and an oil phase.

### CROSS-REFERENCE TO RELATED APPLICATIONS

This application is a filing under 35 U.S.C. 371 as the National Stage of International Application No. PCT/IB2023/059274 filed Sep. 19, 2023 and entitled “Composition Useful in Sulfate Scale Removal”, which claims priority Canadian Patent Application No. 3178243 filed Sep. 30, 2022, which are hereby incorporated by reference in their entirety.

### FIELD OF THE INVENTION

The present invention is directed to a composition for use in energy production operations, more specifically to compositions used in the removal of petroleum-contaminated barium sulfate scale.

### BACKGROUND OF THE INVENTION

Scaling, or the formation and consequent deposition of mineral deposits can occur on surfaces of metal, rock, or other materials. Scale is caused by a precipitation process as a result of a change in pressure and temperature and the subsequent change in the composition of a solution (commonly water) and is also commonly observed due to incompatibilities of seawater and formation water. Sulfates in the injected seawater react with naturally occurring barium in the formation water to induce barium sulfate scale.

Typical scales consist of e.g. calcium carbonate, calcium sulfate, barium sulfate, strontium sulfate, iron sulfide, iron oxides, or iron carbonate.

In some cases, scale deposits restrict or even shut-off the production conduit if the produced water composition flow path is severely affected by a change in pressure and/or temperature due to wellbore equipment, such as downhole chokes or flow controls. In addition to produced formation water scaling issues due to the mineral content, also other sourced water utilized in well operations can be potential sources of scaling minerals, including water utilized in water flood or injection operations or geothermal operations and associated downhole and surface equipment.

The precipitation of sulfate scales can occur at any point in the production, injection, or disposal well cycle, and can also be caused by incompatibilities of injected water and formation water, in addition to the changes in temperature and pressures mentioned above, as well as wellbore additives or upsets in the flow equilibrium. Scale on surface equipment (e.g. heat exchangers, piping, valves, flow-control devices) is also a catalyst for sulfate scales. In offshore oil & gas operations, seawater is often injected into reservoirs for pressure maintenance, and as seawater has a high content of sulfate ions and formation water or drilling fluids often have a high content of barium, calcium, and/or strontium ions stripped from the formation, mixing these waters causes sulfate mineral precipitation. Sulfate scaling on surface equipment, such as heat exchangers and the associated piping, is a major issue for the industry as well as it typically needs to be managed by mechanical means such as disassembling the equipment in question, manually cleaning the scale and reassembling is very time consuming and expensive and, in some cases, causes operations or production to cease, further adding to the associated costs. Having a chemical solution that can treat these sulfate scales with minimal agitation and at lower temperatures would be very advantageous for the industry. As the multiple sulfate composition scaling challenges occur offshore and onshore are typically very difficult to manage efficiently as a whole. Having a sulfate dissolver that solubilizes all typical scales encountered either individually or as a composition is advantageous for the industry versus having to deploy specific chemistry for each type of scale or manage the scaling issues with mechanical means.

The most obvious way of preventing a scale from forming during production is to prevent the supersaturation of the brine being handled, although not always possible, and manage the flow path of fluids to minimize differentials of pressure, temperature, and rate. This may sometimes be possible by altering the operating conditions of the reservoir, for example by ensuring that the wellbore pressure is sufficient to prevent the liberation of gas and by injecting water which is compatible with formation water. However, the economics usually dictate that the use of inhibitors or batch treating any precipitated scale is preferred to manage costs.

Controlling scale with the use of inhibitors as well as understanding and mitigating scaling tendencies is important for both production and injection wells along with associated water treatment infrastructure, as well as also having a solution or economical means of treating any scaling that does occur, even after best practices have been implemented during the production cycle.

The design of scale treatment programs requires extensive knowledge of scaling/chemistry theory and a broad base of practical operational experience to be successful. Applications occasionally present themselves in which the ideal selection and thus compatibilities of chemicals and fluids may be beyond the scope of a wellsite engineer's experience or theoretical knowledge. Rules of thumb and general formulas may not be adequate to achieve success. Selection procedures based on broader experience and more in-depth knowledge may be required. Analysis of deposits and dissolver screening ideally should be performed when considering a potential scale dissolving application, therefore the scale that is causing the “operational challenges” will have to be analyzed.

The most common sulfate scales are barium, calcium, and strontium. These alkaline earth metal salts have many similar properties and often precipitate in conjunction forming problematic and integrated sulfate scales. In some cases, they are also comingled with other common scales such as calcium carbonate and or iron-based examples. The deposition of barium scale, in particular, is a serious problem for oil and gas producers globally, causing fouling in the wellbore resulting in reduced or lost production and surface-related processing equipment also resulting in a loss or reduction of revenue. These scales not only restrict the hydrocarbon flow from the formation resulting in lost production, and since the formation or injection water is saturated with sulfates, the continued deposition causes fouling and potential failures of critical equipment such as perforations, casing, tubes, valves, and surface equipment, all with the potential to reduce the rate of oil production and result in substantial lost revenue. There is a need in the industry for an effective solution to this ongoing challenge. Sulfate scales such as radium sulfate, barium sulfate, calcium sulfate, etc.—are sometimes referred to as NORM scales due to their solubility characteristics—typically 0.0023 g/l in water—are more difficult to deal with than carbonate scales. Sulfate scales are not soluble in traditional acid scale dissolvers. Radium sulfate, while not being the most common sulfate scale represents a challenge in its removal as it is often embedded in barium sulfate scale and is also radioactive and thus can carry an exposure risk and cause very expensive clean-up or disposal costs of tubing and downhole equipment etc. when brought out of the well during a workover, general service or abandonment. Having a chemical that can be used to wash these components while still in the well and effectively clean/remove the NORM materials leaving them down-hole, allowing the operator to greatly reduce handling/disposal costs related to NORM-containing wells is very advantageous.

Once this water-insoluble scale has formed, it is extremely difficult to remove with existing chemical options on the market and is typically dealt with mechanically or by a complete replacement of affected equipment.

The solubility of barium sulfate is reported to be approximately 0.0002448 g/100 ml (20° C.) and 0.000285 g/100 ml (30° C.). Existing methods to remove sulfate scale include mechanical removal and/or low-performance scale dissolvers currently on the market, but both have limitations and disadvantages. Mechanical removal involves the use of milling tools, scrapers, or high-pressure jetting, and/or disassembly of key production equipment causing substantial downtime for production and processing equipment. These methods have limited efficiency as the scale is extremely hard to remove, often forming in areas beyond the reach of the mechanical equipment as many facilities have welded joints and limited access. High-pressure jetting will typically only remove the surface of the scale.

Sulfate scale dissolvers were developed to overcome the low solubility of these types of scales. Sulfate scale dissolvers work by chelating or coordinating the sulfate present allowing it to be dissolved in the water. To assist the rate of reaction or increase the speed and efficiency of dissolution, these products are typically deployed at elevated temperatures of 50° C. to 90° C. but can show effectiveness at temperatures of up to 170° C. Sulfate scale dissolution will as a result take far longer than for example carbonate scale dissolution in and acid as there is an immediate and rapid reaction occurring, unlike with common sulfate scale dissolvers. Typical scale dissolvers such as ethylenediaminetetraacetic acid (EDTA), and variations of this molecule (such as diethylenetriaminepentaacetic acid DTPA) are used by the industry to dissolve sulfate scale with some limited success, and sequestering the barium, calcium, and strontium ions. However, this process is time-consuming, requires higher temperatures (usually above 75° C.), agitation, and has limited dissolution capacity per gallon.

The following includes some patent disclosures of sulfates scale removers. U.S. Pat. No. 4,980,077 A demonstrates that alkaline earth metal scales, especially barium sulfate scale deposits can be removed from oilfield pipe and other tubular goods with a scale-removing composition comprising an aqueous alkaline solution having a pH of 8 to 14, a polyaminopolycarboxylic acid, preferably EDTA or DTPA, and a catalyst or synergist comprising an oxalate anion. It is stated that when the scale-removing solution contacts a surface containing a scale deposit, substantially more scale is dissolved at a faster rate than previously possible.

PCT patent application WO 1993024199 A1 demonstrates the use of low-frequency sonic energy in the sonic frequency range to enhance the dissolution of alkaline earth metal scales using a scale-removing solvent comprising an aqueous alkaline solution having a pH of 8 to 14 and containing EDTA or DTPA and a catalyst or synergist, preferably an oxalate anion. It is stated that when the scale-removing solvent contacts the surface containing a scale deposit while simultaneously transmitting low-frequency sonic energy through the solvent, substantially more scale is dissolved at a faster rate than previously possible.

U.S. Pat. No. 4,030,548A demonstrates a barium sulfate scale (or solid) can be dissolved economically by flowing a stream of relatively dilute aqueous solution of aminopolyacetic acid salt chelating agent into contact with and along the surfaces of the scale while correlating the composition and flow rate of the solution so that each portion of solution contains an amount of chelant effective for dissolving barium sulfate and the upstream portions of the scale are contacted by portions of the solution which are unsaturated regarding the barium-chelant complex.

U.S. Pat. No. 3,625,761A demonstrates a method of removing a deposit of alkaline earth metal sulfate scale in an aqueous system which comprises contacting said scale deposit with a treating composition heated to a temperature in the range of 86 to 194° F. consisting essentially of an aqueous alkaline solution containing 4 to 8 percent by weight of disodium hydrogen ethylenediaminetetraacetate dihydrate and having a pH in the range of 10 to 13 for a period sufficient to dissolve at least some of the said scale, acidifying said solution to decrease the pH thereof to a pH in the range of 7 to 8 with an acid selected from the group consisting of sulfuric acid, hydrochloric acid, oxalic acid, a mixture of sulfuric acid and oxalic acid, and a mixture of hydrochloric acid and oxalic acid, to precipitate any alkaline earth metal ion present.

U.S. Pat. No. 5,084,105A demonstrates that alkaline earth metal scales, especially barium sulfate scale deposits can be removed from oilfield pipe and other tubular goods with a scale-removing composition comprising an aqueous alkaline solution having a pH of 8 to 14, preferably 11 to 13, of a polyaminopolycarboxylic acid, preferably EDTA or DTPA and a catalyst or synergist comprising a monocarboxylic acid, preferably a substituted acetic acids such as mercaptoacetic, hydroxyacetic acid or aminoacetic acid or an aromatic acid such as salicylic acid. The description states that when the scale-removing solution is contacted with a surface containing a scale deposit, substantially more scale is dissolved at a faster rate than is possible without the synergist.

U.S. Pat. No. 7,470,330 B2 demonstrates a method of removing metal scale from surfaces that includes contacting the surfaces with first an aqueous solution of a chelating agent, allowing the chelating agent to dissolve the metal scale, acidifying the solution to form a precipitant of the chelating agent and a precipitant of the metal from the metal scale, isolating the precipitant of the chelating agent and the precipitant of the metal from the first solution, selectively dissolving the precipitated chelating agent in a second aqueous solution, and removing the precipitated metal from the second solution is disclosed. This is understood to be a multi-step process which would cause longer shutdown in production and is not determined to actually be applicable in the field.

Crude oil or petroleum is generally identified by the content of various hydrocarbons therein. The first class of compounds making up petroleum are paraffins. These are the most common hydrocarbons in crude oil. The second class of compounds making up petroleum are naphthenes. The third class of compounds making up petroleum are aromatics but these represent only a small percentage of the total petroleum extracted. During production, the accumulation of barium scale within tubing where petroleum flows will restrict the flow and may, if unchecked, completely block the flow in some cases. The removal of barium sulfate scale, as discussed above, requires shutdown of production and depending on the situation may take several hours to several days to re-establish sufficient flow to re-initiate production.

Despite the existing prior art, there are very few commercially successful compositions available to remove barium sulfate scale, the situation is made even more complex since most barium sulfate scale occurs in wellbores, pipes and other equipment associated with either oil production and/or oil exploration. Thus, the removal of petroleum-contaminated barium sulfate scales presents an even more challenging task for operators.

When sulfate scale is co-mingled/coated/covered with a petroleum-based product, it is understood to be contaminated by such. Petroleum contamination makes the scale surface hydrophobic and therefore the common aqueous descaling/chelating compositions have substantially more difficulty interacting or contacting the barium sulfate scale due to this barrier. Consequently, this petroleum contamination dramatically reduces the efficiency of the scale dissolver.

There thus exists a profound and commercial need for compositions and methods capable of removing very difficult to remove petroleum-contaminated or coated barium sulfate scales present on equipment involved in oilfield operations.

### SUMMARY OF THE INVENTION

According to the first aspect of the present invention, there is provided an aqueous caustic composition comprising an emulsion for use in removing petroleum-contaminated barium sulfate scale from a surface contaminated with such, said composition comprising:
a chelating agent and a counterion component selected from the group consisting of: Li₅DTPA; Na₅DTPA; K₅DTPA; Cs₅DTPA; Na₄EDTA; K₄EDTA; TEAH₄DTPA; and TBAH₅DTPA;
a scale removal enhancer;
a non-ionic surfactant; and
and said emulsion comprising:
water;
optionally, a hydrotrope;
optionally, 3-Methoxy-3-methyl-1-butanol (MMB) or isopropanol;
an alkanolamine;
a surfactant selected from a group consisting of: a sulfonate surfactant; an alcohol ethoxylate surfactant; and a combination thereof
a non-ionic surfactant; and
an oil phase.

Preferably, said an alkanolamine is monoethanolamine (MEA).

According to a preferred embodiment of the present invention, said sulfonate surfactant is selected from the group consisting of: DDBSA: petroleum sulfonate; and disulfonate surfactants.

According to a preferred embodiment of the present invention, said alcohol ethoxylate surfactant is Lutensol XL90.

According to a preferred embodiment of the present invention, said a non-ionic surfactant is an alkyl polyglycoside. Preferably, said alkyl polyglycoside is selected from the group consisting of: Triton BG-108; Triton CG-110®; Triton CG-425®; Basoclean® 80; and Basoclean® 100.

According to a preferred embodiment of the present invention, said oil phase is selected from the group consisting of: napthenic oil; a paraffinic oil; a terpene and a combination thereof. Preferably, said napthenic oil is selected from the group consisting of: Pale Oil 40; Pale Oil 60; and a combination thereof. Preferably, said paraffinic oil is a mineral oil. Preferably, said terpene is citral.

According to a preferred embodiment of the present invention, the emulsion makes up to 20 vol % of the total volume of the composition. Preferably, the pH of the composition ranges from 10 to 11.

According to a preferred embodiment of the present invention, the hydrotrope is selected from the group consisting of: an alkyl glucoside: an alkyldiphenyloxide disulfonate; and a combination thereof. Preferably, the alkyl glucoside is a C₆-C₁₂ alkyl glucoside. More preferably, the C₆-C₁₂ alkyl glucoside is selected from the group consisting of: hexyl glucoside; octyl glucoside; decyl glucoside; dodecyl glucoside and combinations thereof.

According to a preferred embodiment of the present invention, the emulsion comprises:
between about 40 wt % to about 80 wt % of water;
between about 0.25 wt % to about 2 wt % of said alkanolamine;
between about 1 wt % to about 10 wt % of said surfactant;
between about 5 wt % to about 20 wt % of said non-ionic surfactant; and
between about 0.25 wt % to about 3 wt % of said oil phase.

According to the first aspect of the present invention, there is provided a use of an aqueous caustic composition comprising an emulsion for use in removing petroleum-contaminated barium sulfate scale from a surface contaminated with such, said composition comprising:
a chelating agent and a counterion component selected from the group consisting of: Li₅DTPA; Na₅DTPA; K₅DTPA; Cs₅DTPA; Na₄EDTA; K₄EDTA; TEAH₄DTPA; and TBAH₅DTPA;
a scale removal enhancer;
a non-ionic surfactant; and
and said emulsion comprising:
water;
optionally, a hydrotrope;
optionally, 3-Methoxy-3-methyl-1-butanol (MMB) or isopropanol;
an alkanolamine;
a surfactant selected from a group consisting of: a sulfonate surfactant; an alcohol ethoxylate surfactant; and a combination thereof;
a non-ionic surfactant; and
an oil phase.

According to the first aspect of the present invention, there is provided a method of removing barium sulfate scale from a surface contaminated with at least one petroleum product, said method comprising:
providing an aqueous caustic composition comprising an emulsion for use in removing petroleum-contaminated barium sulfate scale from a surface contaminated with such, said composition comprising:
   a chelating agent selected from the group consisting of: Li₅DTPA; Na₅DTPA; K₅DTPA; Cs₅DTPA; Na₄EDTA; K₄EDTA; TEAH₄DTPA; and TBAH₅DTPA;
   optionally, a scale removal enhancer;
   a non-ionic surfactant; and
and said emulsion comprising:
   water;
   optionally, a hydrotrope;
   optionally, 3-Methoxy-3-methyl-1-butanol (MMB) or isopropanol;
   an alkanolamine;
   a surfactant selected from a group consisting of: a sulfonate surfactant; an alcohol ethoxylate surfactant; and a combination thereof;
   a non-ionic surfactant; and
   an oil phase:
exposing said surface to said aqueous caustic composition;
allowing sufficient time of exposure to remove said barium sulfate scale and said at least one petroleum product from said contaminated surface.

According to a preferred embodiment of the present invention, the scale removal enhancer is selected from the group consisting of: potassium carbonate; potassium formate; cesium formate (C₈COOH); cesium carbonate (C₈CO₃); and combinations thereof.

### DETAILED DESCRIPTION OF A PREFERRED EMBODIMENT

The inventors have previously noted that chelating agents such as EDTA (Ethylenediaminetetraacetic acid) or DTPA (diethylenetriaminepentaacetic acid) can dissolve non-contaminated barium sulfate depending substantially on the size and ion strength of the counterion.

Tests performed have indicated that besides the nature of the counterion, an excess of the counterion also improves the solubility. K₅DTPA was tested in conjunction with KCl, K₂CO₃, and KOOCH (potassium formate). It seems that the counterion also plays a large role as K₂CO₃ (with the larger anion) was much more effective than KCl (with a small anion).

By the addition of potassium carbonate to K₅DTPA, the same solubility numbers can be attained at a lower pH. Instead of 13.5, a pH of 11 was sufficient to obtain comparable solubility numbers. This represents a considerable difference. This allows to conduct scale removal operations at a lower pH and therefore increases the safety of the personnel handling the remover or anyone in the surrounding area.

According to a preferred embodiment of the present invention, the petroleum-contaminated barium sulfate scale removing composition provides improved rates of scale dissolution. This, in turn, reduces the downtime for wells where the scale is being removed. It also reduces the cost of such treatment by limiting the treatment time.

Previous testing has shown the inventors that the compositions tested for removing non-contaminated barium sulfate scale permit the removal thereof at a much lower pH than what has been practiced to date. Indeed, such a composition can effectively remove the barium scale under conditions where the pH is 11, rather than other scale removal compositions which require conditions where the pH is 13. A preferred composition according to the present invention may remove up to 30 kg/m³ of non-contaminated BaSO₄ scale with a pH of 10. When using the term “non-contaminated BaSO₄ scale”, it should be understood to the person skilled in the art, that the barium sulfate scale is not contaminated by a petroleum product or a petroleum-based product.

According to a preferred embodiment of the present invention, a composition for removing petroleum-contaminated barium sulfate scale permits the removal thereof with a higher dissolution capacity. This, in turn, allows for reducing the volume of scale remover necessary. This also decreases transport costs and many other related items resulting from the usage of lower volumes of scale remover.

According to a preferred embodiment of the present invention, a composition for removing petroleum-contaminated barium sulfate scale permits the removal thereof at lower temperature and pH than other barium sulfate scale removing chemistry. This results in safer treatment conditions for individuals involved in this process, along with reduced transportation, storage and logistical challenges associated with high pH chemistry.

According to a preferred embodiment of the present invention, a composition for removing petroleum-contaminated barium sulfate scale comprises an emulsion. The emulsion is comprised of a mixture of surfactants and an oil phase. In some cases, the emulsion contains cosolvents which could be short-chain alcohol. Preferably, the surfactant mixture in the emulsion can be a mixture of alkyl poly glucoside and dodecylbenzene sulfonate MEA or a mixture of alkyl poly glucoside and alcohol ethoxylate-based surfactants. The oil phase could be terpene-based such as citral or petroleum based such as pale oil 40. Preferably, the emulsion was formulated to ensure solubility of the components at a pH of 10 to 11 as the high pH stretches ethylene oxide chains exposing their hydrophobic backbone. Examples of alcohol ethoxylate-based surfactants include, but are not limited to: aromatic ethoxylates and branched or linear ethoxylates of the following formula: H₃C—(CH₂)ₘ—(OC₂H₄)ₙOH where m is between 6 and 12 and n is between 8 and 16, preferably m is 9 and n is between 9 to 14.

### Preparation of a Base BSD Composition

To prepare a base BSD (barium scale dissolver) composition, combine 334 g of distilled water with 300 g of potassium hydroxide (40% (w/v)) solution and 197 g of diethylenetriamine pentaacetate (DTPA). The resulting composition was mixed thoroughly. The constituents of the resulting composition are listed in Table 1 below. Other similar compositions were prepared as seen in Tables 2 and 3.

TABLE 1
The composition of base BSD

| Constituent | Content (vol. %) |
|---|---|
| Water | 37.3% |
| DTPA | 22.1% |
| KOH, 45% | 33.3% |
| K₂CO₃ | 7.3% |

TABLE 2
The composition of Example #2 (BSD-B)

| Constituent | Content (vol. %) |
|---|---|
| Water | 40.6% |
| DTAP | 13.1% |
| KOH, 45% | 19.7% |
| K₂CO₃ | 4.4% |
| Lutensol ® XL90 | 0.2% |
| Triton ® BG-10 | 22.1% |
| Methanol | 40.6% |

TABLE 3
The composition of Example #3 (BSD-C)

| Constituent | Content (vol. %) |
|---|---|
| Water | 61.4% |
| DTAP | 11.7% |
| KOH, 45% | 17.7% |
| K₂CO₃ | 3.9% |
| Mitaine | 0.9% |
| Sodium Gluconate | 4.3% |

### Laboratory Testing of Scale Dissolution

The sample selected for the solubility testing origins from an oilfield tubular containing sulfate scale crystals originally used for demonstration purposes. Crystals of non-contaminated barium sulfate scale were removed from the tubular to be used for the solubility testing. 200 mL of the composition (K₅DTPA 20 wt % and 5 wt % K₂CO₃) was used. A weighed portion of the oilfield sulfate scale sample was submerged in 200 mL of each de-scaling composition. A small magnetic stirrer is added to create a very minimal vortex, creating a small movement of fluid without rigorously stirring the fluid. The fluid was heated to 70° C.

### Results

25.165 grams of non-contaminated oilfield sulfate scale was weighed and added to the fluid. The stirrer and heater were started. After 1 hour a slight colouring of the fluid was observed. After 4 hours at temperature when no continued visual reduction of the scale was observed, the fluid was filtered and the filter was rinsed with water, dried and weighted. The maximum scale solubility was reached and subsequently calculated.

The base barium scale dissolver composition (used in later testing and referred to as “base BSD”) comprises a 20 wt % solution of K₅DTPA and 5 wt % K₂CO₃. The base BSD was able to dissolve 52.97 grams per litre of scale at 70° C. The testing was also carried out with a commercially available product (Barsol NS™), which is alkali/EDTA based and with EDTA. The Barsol NS™ product was capable of dissolving 24.19 grams per litre. While EDTA alone only dissolved around 6 grams per litre. Under identical conditions, base BSD was shown to have more than double the performance of Barsol NS™.

Moreover, the compositions according to the present invention used are quite environmentally safe. This represents a major advantage over any known chemically-based methods of the removal of petroleum-contaminated barium scale. Another advantage to the compositions according to preferred embodiments of the present invention includes the speed of dissolution which is considerably faster than any known commercial compositions. Another advantage of preferred compositions according to the present invention is that they can be employed on wells according to a one-step process and thus are very desirable to operators which deal with petroleum-contaminated barium sulfate scale issues.

Base BSD is a highly alkaline and chelating agent solution used for dissolving barium sulfates scales. It is a mixture of KOH and DTPA.

In general, nonionic alkoxylated alcohol surfactants are not soluble in high alkaline high chelating agents' solutions. However, nonionic alkoxylated alcohols such as Lutensol® XL90 are very effective wetting and emulsifying agents.

It was previously found that relatively low dosages of C₆-alkyl glucoside, C₈-alkyl glucoside, C₈-C₁₀-alkyl glucoside, or alkyldiphenyloxide disulfonate can dissolve higher concentrations of nonionic alkoxylated alcohols high alkaline high chelating agents' solutions compared to other hydrotropes such as SXS and SCS. Other known hydrotropes which may be considered when formulating a composition according to a preferred embodiment of the present invention include but are not limited to: TRITON™ H-55; Plurafac™ CS-10; Sodium Xylene Sulfonates (SXS); sodium cumene sulfonates (SCS); Armoclean™ 6040 Hexyl Glucoside: Armoclean® 6000 (AG6202) Octyl Glucoside; and Basoclean™ 80 (C₈-C₁₂ alkyl Glucoside).

TRITON™ H-55 is a phosphate polyether ester hydrotrope which is chemically stable in acidic & alkaline solutions. Plurafac™ CS-10 is an anionic polycarboxylate surfactant that is soluble in high alkaline solutions such as base BSD. Sodium Xylene Sulfonates (SXS) is a commonly used hydrotrope to solubilize surfactants. However, it is well known that SXS is not highly efficient to dissolve high concentration of nonionic alkoxylate such as Lutensol™ XL90 in high alkaline solutions. Armoclean™ 6040 Hexyl Glucoside is a very efficient hydrotrope to solubilize surfactants. It is highly efficient to dissolve a high concentration of nonionic alkoxylate such as Lutensol™ XL90 in high alkaline solutions. Armoclean™ 6000 (AG6202) in base BSD presents a unique phase behavior compared to Armoclean™ 6040 when added to base BSD. However, as the concentration of Armoclean™ 6000 (AG6202) increased the solution became turbid. At high concentration of Armoclean™ 6000, the solution became clear. Turbidity means that the surfactant is unstable in the solution and presents in the form of large flocs. Basoclean™ 80 (C₈-C₁₂ alkyl Glucoside) is another hydrotrope that is octyl-decyl alkyl glucoside. It was found that Basoclean™ 80 works very effectively.

According to a preferred embodiment of the present invention, there is provided a one-step process for removing petroleum-contaminated barium sulfate scale inside a wellbore, said process comprises the following steps:
providing a liquid composition comprising:
   a chelating agent selected from the group consisting of: Li₅DTPA; Na₅DTPA; K₅DTPA; Cs₅DTPA; Na₄EDTA; K₄EDTA; TEAH₄DTPA; and TBAH₅DTPA;
   a scale removal enhancer;
   an emulsion composition
exposing a surface contaminated with petroleum-contaminated barium sulfate scale to the liquid composition;
allowing sufficient time of exposure to remove some or all of the petroleum-contaminated barium sulfate scale from the contaminated surface. The person skilled in the art will understand that what is meant by “one-step” is that there is a single treatment step in the process (or method) to remove barium sulfate scale.

According to a preferred embodiment of the present invention, there is provided a one-step process for removing petroleum-contaminated barium sulfate scale inside a wellbore, said process consisting of the following steps:
providing a liquid composition comprising:
   a chelating agent selected from the group consisting of: Li₅DTPA; Na₅DTPA; K₅DTPA; Cs₅DTPA; Na₄EDTA; K₄EDTA; TEAH₄DTPA; and TBAH₅DTPA;
   a scale removal enhancer;
   an emulsion composition
exposing a surface contaminated with petroleum-contaminated barium sulfate scale to the liquid composition;
allowing sufficient time of exposure to remove some or all of the petroleum-contaminated barium sulfate scale from the contaminated surface. The person skilled in the art will understand that what is meant by “one-step” is that there is a single treatment step in the process (or method) to remove barium sulfate scale.

### Emulsion Soluble in Base BSD

Several emulsion compositions were tested for their solubility in the Base BSD composition. However, none of those products is soluble in the Base BSD composition. Hence, a new nano product was developed specifically for solubility in the Base BSD composition.

The main reason for the insolubility of emulsions in the Base BSD composition is the high pH and high electrolyte strength of the Base BSD composition that prevents the solubility of the DDBSA and alcohol ethoxylate used in emulsions.

The emulsion composition according to a preferred embodiment of the present invention was made with sugar-based nonionic surfactant that can tolerate such extreme conditions. It was previously found that relatively low dosages of C₆-alkyl glucoside, C₈-alkyl glucoside, C₈-C₁₀-alkyl glucoside, or alkyldiphenyloxide disulfonate can dissolve higher concentrations of nonionic alkoxylated alcohols high alkaline high chelating agents' solutions compared to other hydrotropes such as SXS and SCS. Other known hydrotropes which may be considered when formulating a composition according to a preferred embodiment of the present invention include but are not limited to: TRITON™ H-55; Plurafac™ CS-10; Sodium Xylene Sulfonates (SXS); sodium cumene sulfonates (SCS); Armoclean™ 6040 Hexyl Glucoside; Armoclean® 6000 (AG6202) Octyl Glucoside; and Basoclean™ 80 (C₈-C₁₂ alkyl Glucoside).

The emulsion composition according to a preferred embodiment of the present invention was developed and tested for solubility in different the base BSD composition, BSD-B, BSD-C, etc. and it has good solubility in such compositions.

Several different barium scale dissolving compositions were loaded with 2 gpt of an emulsion composition to form a composition according to a preferred embodiment of the present invention and were tested for their efficiency in breaking oil-based mud (OBM). Of all the compositions tested, only BSD-B was able to break the mud completely. In this series of testing, the mud tested did not contain any barite particles.

Solubility testing was conducted utilizing the Base BSD composition, 1% Nano-X13 in the Base BSD composition and 1% Nano-X11-3 in the Base BSD composition with barium sulfate for 24 hours at 60° C. (140° F.). The maximum solubility for the Base BSD composition was 75.1%, for Nano-X13 it was 96.8% and for Nano-X11-3, it was 96.9%.

### Solubility of Different Emulsions in the Base BSD Composition

### Procedure

Different proportions of emulsions were mixed with the base BSD composition and stirred using a magnetic stirrer. Then, the samples were left quiescent overnight before performing visual observation. The constituents of the resulting composition are listed in Table 4 below. Subsequent compositions comprising both the base BSD and various emulsions were prepared, the compositions are listed in Tables 5, 6, 7, and 8 (below).

TABLE 4
Composition of various emulsion compositions tested

| | emulsion | emulsion | emulsion | emulsion | emulsion | emulsion | emulsion |
|---|---|---|---|---|---|---|---|
| | C170 | C160 | C260 | C225 | C217 | P225 | P215 |
| Product Name | wt % | wt % | wt % | wt % | wt % | wt % | wt % |
| Water DI | 30 | 40 | 39.77 | 75.885 | 82.92 | 75.885 | 84.425 |
| MEA | — | — | 1.73 | 0.865 | 0.58 | 0.865 | 0.576 |
| Triton Hand | 25 | 15 | 15 | 7.5 | 5 | 7.5 | 5 |
| Sanitizer** | | | | | | | |
| Novel 23E7 | 20 | 20 | 20 | 10 | 6.67 | 10 | 6.666 |
| DDBSA | | | 8.5 | 4.25 | 2.83 | 4.25 | 2.833 |
| DOWFAX | 10 | 10 | | | | | |
| C10L | | | | | | | |
| Citral (CI-C) | 15 | 15 | 15 | 1.5 | 2 | | |
| Pale Oil 40 | | | | | | 1.5 | 0.5 |
| Total | 100 | 100 | 100 | 100 | 100 | 100 | 100 |

**Triton hand sanitizer is a commercial product comprising over 75% ethanol used as a hand sanitizer.

TABLE 5
Mixtures of the Base BSD composition and emulsion C217

| | BSD-1 | BSD-2 | BSD-3 | BSD-4 | BSD-5 | BSD-6 | BSD-7 |
|---|---|---|---|---|---|---|---|
| Base BSD | 19 | 18 | 15 | 10 | 5 | 2 | 1 |
| composition | | | | | | | |
| (g) | | | | | | | |
| emulsion | 1 | 2 | 5 | 10 | 15 | 18 | 19 |
| C217 (g) | | | | | | | |
| | 2- | 2-phases | 2- | 2- | 1- | 1- | 1- |
| | phases | | phases | phases | phase | phase | phase |

TABLE 6
Mixtures of the Base BSD composition and emulsion C260

| | BSD-8 | BSD-9 | BSD-10 |
|---|---|---|---|
| Base BSD composition | 9.0 | 5 | 1 |
| (g) | | | |
| emulsion C260 (g) | 1 | 5 | 9 |
| | 2- | 2-phases | 2-phases |
| | phases | | |

TABLE 7
Mixtures of Base BSD and emulsion C160

| | BSD-11 | BSD-12 | BSD-13 |
|---|---|---|---|
| Base BSD composition | 9.0 | 5 | 1 |
| (g) | | | |
| Emulsion C160 (g) | 1 | 5 | 9 |
| | 2- | 2-phases | 1-phases |
| | phases | | |

TABLE 8
Mixtures of the Base BSD composition and emulsion P215

| | BSD-14 |
|---|---|
| Base BSD composition | 19.8 |
| (g) | |
| Emulsion P215 (g) | 0.2 |
| | 2-phases |

### Results

Based on the results in the above tables, none of the different versions of Nano-OSD emulsions were solubilized in the base BSD composition. However, the base BSD composition was found to be miscible in emulsion C217 and C160 at low concentrations<25%.

### New Nano-X for Solubility in the Base BSD Composition

Based on these results, a new nano product is needed to be soluble in the Base BSD composition. It is hypothesized that the insolubility of Nano-OSD in the Base BSD composition is due to the high pH and high electrolyte strength of the Base BSD composition that prevents the solubility of the DDBSA and alcohol ethoxylate used in emulsions. According to a preferred embodiment of the present invention, an alkyl polyglucoside surfactant was incorporated in the emulsion formulation to allow for solubility of either DDBSA or alcohol ethoxylate (whichever one is employed in the composition).

According to a preferred embodiment of the present invention, an emulsion composition was made by replacing (in part or in whole) either an alcohol ethoxylate nonionic surfactant or DDBSA anionic surfactant which are insoluble in high pH and high electrolyte strength with a sugar-based nonionic surfactant that can tolerate such extreme conditions.

### Procedure

A couple of sugar-based surfactants (Triton® BG-10 and Triton® CG-425) along with a different solvent, MMB (3-Methoxy-3-methyl-1-butanol) or ethanol were tested. The idea of using MMB is to introduce steric hindrance keep the micelles from inverting at high pH and high electrolyte concentration. According to a preferred embodiment of the present invention, the solvent is isopropanol.

According to a preferred embodiment of the present invention, other alkyl polyglycosides such as Triton CG-110, Triton CG-425, Basoclean 80, Basoclean 100, etc. could be used in place of Triton BG-10.

According to a preferred embodiment of the present invention, the oil phase can be napthenic like Pale Oil 40, Pale Oil 60, etc. or paraffinic oil like mineral oil, or it may comprise a terpene like Citral.

Various emulsion compositions according to a preferred embodiment of the present invention were prepared with different ratios of surfactants, and different concentration of MMB and Pale Oil-40. Pale oil 40 was added at increments of 0.25 mL each.

The compositions were observed visually and then those that are clear 1-phase solution were tested for solubility in the Base BSD composition (at 50% concentration) at 2 gpt loading.

### Results

The compositions and the results are summarized in Tables 5-10 (below). A few compositions were identified for their solubility in the base BSD composition (at 50% concentration).

Table 9 shows that only at low concentration or even absence of MMB, emulsion was formed using Triton® BG-10, and was soluble in base BSD (50%). However, Triton® CG-425 (Table 10) could not form stable emulsions at any concentration of MMB except in the case of composition Nano-X9. Hence, Triton® BG-10 was a preferred candidate for further screening.

Various emulsion compositions according to a preferred embodiment of the present invention labelled Nano-X1, X11, and X12 were made. Tables 9 and 13 shows that emulsions were made with either 0.5 or 1% MMB and different concentrations of Pale Oil 40. However, none of those were found to be soluble in the base BSD composition at 2 gpt dosage.

Table 11 shows that emulsions were made with 1% MMB and different concentrations of Pale Oil 40. However, only emulsions with the highest concentration of pale Oil 40 (Nano-X11-3) is soluble in the base BSD composition at 2 gpt dosage.

Finally, the ratio of DDBSA and Triton® BG-10 was studied. Tables 12 and 14 show that emulsions were formed in absence of MMB for the different ratios of DDBSA and Triton® BG-10. However, only emulsions with relatively higher concentration of Triton® BG-10 were soluble in the base BSD composition.

TABLE 9
Composition and stability of several tested Barium
Scale dissolving blends comprising an emulsion

| | Nano- | Nano- | Nano- | | Nano- | Nano - | |
|---|---|---|---|---|---|---|---|
| | X11 | X12 | X1 | Nano-X2 | X3 | X4 | Nano-X5 |
| | wt % | wt % | wt % | wt % | wt % | wt % | wt % |
| Water DI | 74.5 | 74 | 73.5 | 69.5 | 64.5 | 59.5 | 54.5 |
| MMB | 0 | 0.5 | 1 | 5 | 10 | 15 | 20 |
| MEA | 0.5 | 0.5 | 0.5 | 0.5 | 0.5 | 0.5 | 0.5 |
| DDBSA | 5 | 5 | 5 | 5 | 5 | 5 | 5 |
| Triton BG-10 | 15 | 15 | 15 | 15 | 15 | 15 | 15 |
| Pale Oil 40 | 5 | 5 | 5 | 5 | 5 | 5 | 5 |
| Total | 100 | 100 | 100 | 100 | 100 | 100 | 100 |
| After 0.25 mL | Clear 1- | Clear | Clear 1- | Clear 1- | Clear 1- | Clear 1- | Clear 1- |
| Pale Oil 40 | phase | 1-phase | phase | phase | phase | phase | phase |
| 2 gpt in Base | 1-phase | 1-phase | 2- | 2-phases | 2-phases | 2-phases | 2-phases |
| BSD | Tyndall | Tyndall | phases | | | | |
| composition | | | | | | | |
| (at 50% | | | | | | | |
| concentration) | | | | | | | |
| After 0.5 mL | | | Clear 1- | 2-phases | Clear 1- | Clear 1- | 2-phases |
| Pale Oil 40 | | | phase | | phase | phase | |
| 2 gpt in BSD- | | | 2- | | | | |
| 40 NEAT | | | phases | | | | |
| (50%) | | | | | | | |

TABLE 10
Composition and stability of several tested barium
scale dissolving blends comprising an emulsion

| | | | | | Nano- |
|---|---|---|---|---|---|
| | Nano-X6 | Nano-X7 | Nano-X8 | Nano-X9 | X10 |
| | wt % | wt % | wt % | wt % | wt % |
| Water DI | 73.5 | 69.5 | 64.5 | 59.5 | 54.5 |
| MMB | 1 | 5 | 10 | 15 | 20 |
| MEA | 0.5 | 0.5 | 0.5 | 0.5 | 0.5 |
| DDBSA | 5 | 5 | 5 | 5 | 5 |
| Triton | 15 | 15 | 15 | 15 | 15 |
| CG-425 | | | | | |
| Pale Oil 40 | 5 | 5 | 5 | 5 | 5 |
| Total | 100 | 100 | 100 | 100 | 100 |
| 0.25 mL | 2-phases | 2-phases | 2-phases | 1-phase | 2-phases |
| Pale Oil 40 | | | | | |

TABLE 11
Composition and stability of several tested barium
scale dissolving blends comprising an emulsion

| | Nano-X1- | Nano-X1- | Nano-X1- |
|---|---|---|---|
| | 1 | 2 | 3 |
| | wt % | wt % | wt % |
| Water DI | 78.5 | 78 | 77.5 |
| MMB | 1 | 1 | 1 |
| MEA | 0.5 | 0.5 | 0.5 |
| DDBSA | 5 | 5 | 5 |
| Triton BG-10 | 15 | 15 | 15 |
| Pale Oil 40 | 0 | 0.5 | 1 |
| Total | 100 | 100 | 100 |
| After Pale Oil-40 | 1-phase | 1-phase | 1-phase |
| 2 gpt in BSD-40 | 2-phases | 2-phases | 2-phases |
| NEAT (50%) | | | |

TABLE 12
Composition and stability of several tested barium
scale dissolving blends comprising an emulsion

| | Nano-X11- | Nano-X11- | Nano-X11- |
|---|---|---|---|
| | 1 | 2 | 3 |
| | wt % | wt % | wt % |
| Water DI | 79.5 | 79 | 78.5 |
| MMB | 0 | 0 | 0 |
| MEA | 0.5 | 0.5 | 0.5 |
| DDBSA | 5 | 5 | 5 |
| Triton BG-10 | 15 | 15 | 15 |
| Pale Oil 40 | 0 | 0.5 | 1 |
| Total | 100 | 100 | 100 |
| After Pale Oil-40 | 1-phase | 1-phase | 1-phase |
| 2 gpt in BSD-40 NEAT | 2-phases | 2-phases | 1-phase |
| (50%) | | | Tyndall |

TABLE 13
Composition and stability of several tested barium
scale dissolving blends comprising an emulsion

| | Nano-X12- | Nano-X12- | Nano-X12- |
|---|---|---|---|
| | 1 | 2 | 3 |
| | wt % | wt % | wt % |
| Water DI | 79 | 78.5 | 78 |
| MMB | 0.5 | 0.5 | 0.5 |
| MEA | 0.5 | 0.5 | 0.5 |
| DDBSA | 5 | 5 | 5 |
| Triton BG-10 | 15 | 15 | 15 |
| Pale Oil 40 | 0 | 0.5 | 1 |
| Total | 100 | 100 | 100 |
| After Pale Oil-40 | 1-phase | 1-phase | 1-phase |
| 2 gpt in BSD-40 NEAT | 2-phases | 2-phases | 2-phases |
| (50%) | | | |

TABLE 14
Composition and stability of several tested barium
scale dissolving blends comprising an emulsion

| | Nano- | Nano- | | Nano- |
|---|---|---|---|---|
| | X13 | X11-3 | Nano-X14 | X15 |
| | wt % | wt % | wt % | wt % |
| Water DI | 78.75 | 78.5 | 78.25 | 78 |
| MMB | 0 | 0 | 0 | 0 |
| MEA | 0.25 | 0.5 | 0.75 | 1 |
| DDBSA | 2.5 | 5 | 7.5 | 10 |
| Triton BG-10 | 17.5 | 15 | 12.5 | 10 |
| Pale Oil 40 | 1 | 1 | 1 | 1 |
| Total | 100 | 100 | 100 | 100 |
| After Pale Oil-40 | 1-phase | 1-phase | 1-phase | 1-phase |
| 2 gpt in BSD-40 | 1-phase | 1-phase | 2-phases | 2-phases |
| NEAT (50%) | | Tyndall | | |

TABLE 15
Composition and stability of several tested barium scale dissolving
blends comprising an emulsion made with alcohol ethoxylate

| | Nano-XL1 |
|---|---|
| | wt % |
| Water DI | 78.5 |
| MMB | 0 |
| Lutensol XL90 | 5.5 |
| Triton BG-10 | 15 |
| Pale Oil 40 | 1 |
| Total | 100 |
| After Pale Oil-40 | 1-phase |
| 2 gpt in BSD-40 NEAT (50%) | 1-phase Tyndall |

### Emulsion in the Base BSD Composition for Breaking Oil-Based Mud

### Procedure

2 gpt of Nano-X11-3 was added to 10 mL of the Base BSD composition (50%), BSD-40W, BSD-40N and then, mixed with 10 mL of oil-based mud.

### Results

Photographs taken showed that only the composition labelled BSD-B with Nano-X11-3 was able to break the mud. Composition labelled BSD-B alone was also able to break the mud. However, it is worth noting that the mud used in the testing did not contain barite particles.

### Solubility Testing

### Procedure

To determine the total solubility of barite (BaSO₄) in the Base BSD composition with and without addition of a Nano-X emulsion, 7 g of barium sulfate was added to a 125 mL Erlenmeyer flask containing 100 mL of the fluid. The test fluid was heated to 60° C. (140° F.) prior to addition of the scale. The fluid was allowed to react for 24 hours with the solute/scale at 60° C. (140° F.), after which it was vacuum filtered through a P2 and P8 filter paper to determine the mass of solute/scale remaining.

To determine the maximum solubility of barite (BaSO₄) in the Base BSD composition with and without addition of a Nano-X emulsion, 3 g of barium sulfate was added to a 125 mL Erlenmeyer flask containing 100 mL of the fluid and treated as above.

The results for total solubility test results after 24 hours of reaction time at 60° C. (140° F.) are found in Table 16.

TABLE 16
Solubility tests for the test fluids.

| | | | Total | Maximum |
|---|---|---|---|---|
| | | Scale | Solubility | Solubility |
| Test | Fluid | Used | (kg/m³) | (%) |
| A | Base BSD | Barite | 127.51 | |
| | composition | | | |
| B | Base BSD | Barite | | 75.1 |
| | composition | | | |
| C | 1% Nano-X13 in Base | Barite | 139.81 | |
| | BSD composition | | | |
| D | 1% Nano-X13 in Base | Barite | | 96.8 |
| | BSD composition | | | |
| E | 1% Nano-X11-3 in | Barite | 140.18 | |
| | Base BSD | | | |
| | composition | | | |
| F | 1% Nano-X11-3 in | Barite | | 96.9 |
| | Base BSD | | | |
| | composition | | | |

### Observations

When 1% Nano-X13 or 1% Nano-X11-3 is added to the Base BSD composition solution, the barite is dispersed so finely that a large portion is washed through the P8 and the P2 filter papers.

### CONCLUSIONS

Compositions Nano-X11-3, Nano-X13 and Nano-XLI are all soluble in the base BSD composition (50%), BSD-B, and BSD-C.

It was noted that three factors seemed to have an impact on the enhancement of the solubility of the Nano product in BSD: the absence of cosolvent: a relatively higher concentration of Triton BG-10 than DDBSA or alcohol ethoxylate; and a minimum concentration of Pale Oil 40 in the emulsion.

The emulsions Nano-X11-3, Nano-X13 and Nano-XLI increased the solubility of barite in the base BSD composition) from 75% in absence of an emulsion to 97% in the presence of the emulsion.

When the surface equipment is contaminated with barium sulfate scale, or it is deep underground or a hard to access tubing or piping or a combination thereof, the typical treatment exposure consists of circulating or agitating the liquid composition through the tubing or piping until it has been established that the scale has been removed beyond a desirable predetermined point. Hence, in some cases, it is quite possible that the entirety of the scale present is not removed but the resultant removal is sufficient to re-start operations and provide the desired productivity and/or circulation through the affected tubing/piping. The liquid composition can also be heated to improve the removal of the scale and the speed at which the removal is effected and also utilized in conjunction with mechanical intervention methods to further increase effectiveness.

According to another preferred embodiment of the present invention, the method of treatment of petroleum-contaminated BaSO₄ scale wherein the fluid is spotted, i.e. placed in a tube/tank/pipe/equipment in a soaking operation. This may in some instances be somewhat less efficient than circulating the fluid due to the surface reaction nature of the fluid, but it is utilized in some cases to remove enough scale to run tools and also mechanically intervene to achieve the desired result, as an example.

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1-33. (canceled)

34. An aqueous caustic composition comprising an emulsion for use in removing petroleum-contaminated barium sulfate scale from a surface contaminated with barium sulfate and at least one petroleum product, said composition
a chelating agent and a counterion component selected from the group consisting of:
Li₅DTPA; Na₅DTPA; K₅DTPA; Cs₅DTPA; Na₄EDTA; K₄EDTA; TEAH₄DTPA; and TBAH₅DTPA;
a scale removal enhancer;
a non-ionic surfactant; and
and said emulsion comprising:
water;
optionally, a hydrotrope;
optionally, 3-Methoxy-3-methyl-1-butanol (MMB) or isopropanol;
an alkanolamine;
a surfactant selected from a group consisting of: a sulfonate surfactant; an alcohol ethoxylate surfactant; and a combination thereof
a non-ionic surfactant; and
an oil phase.

35. The composition according to claim 34, wherein said an alkanolamine is monoethanolamine (MEA).

36. The composition according to claim 34, wherein said sulfonate surfactant is selected from the group consisting of: DDBSA; petroleum sulfonate; and disulfonate surfactants.

37. The composition according to claim 34, wherein said alcohol ethoxylate surfactant is Lutensol XL90.

38. The composition according to claim 34, wherein said a non-ionic surfactant is an alkyl polyglycoside.

39. The composition according to claim 38, wherein said alkyl polyglycoside is selected from the group consisting of: Triton BG-10®; Triton CG-110®; Triton CG-425®; Basoclean® 80; and Basoclean® 100.

40. The composition according to claim 34, wherein said oil phase is selected from the group consisting of: napthenic oil; a paraffinic oil; a terpene and a combination thereof.

41. The composition according to claim 40, wherein said napthenic oil is selected from the group consisting of: Pale Oil 40; Pale Oil 60; and a combination thereof.

42. The composition according to claim 40, wherein said paraffinic oil is a mineral oil.

43. The composition according to claim 40, wherein said terpene is citral.

44. The composition according to claim 34, wherein the emulsion makes up to 20 vol % of the total volume of the composition.

45. The aqueous composition according to claim 34, wherein pH of the composition ranges from 10 to 11.

46. The aqueous composition according to claim 34, wherein the hydrotrope is selected from the group consisting of: an alkyl glucoside; an alkyldiphenyloxide disulfonate; and a combination thereof.

47. The aqueous composition according to claim 46, wherein the alkyl glucoside is a C₆-C₁₂ alkyl glucoside.

48. The aqueous composition according to claim 47, wherein the C₆-C₁₂ alkyl glucoside is selected from the group consisting of: hexyl glucoside; octyl glucoside; decyl glucoside; dodecyl glucoside and combinations thereof.

49. The composition according to claim 34, wherein the emulsion comprises:
between about 40 wt % to about 80 wt % of water;
between about 0.25 wt % to about 2 wt % of said alkanolamine;
between about 1 wt % to about 10 wt % of said surfactant;
between about 5 wt % to about 20 wt % of said non-ionic surfactant; and
between about 0.25 wt % to about 3 wt % of said oil phase.

50. Use of an aqueous caustic composition comprising an emulsion for use in removing petroleum-contaminated barium sulfate scale from a surface contaminated with such, said composition comprising:
a chelating agent and a counterion component selected from the group consisting of:
Li₅DTPA; Na₅DTPA; K₅DTPA; Cs₅DTPA; Na₄EDTA; K₄EDTA; TEAH₄DTPA; and TBAH₅DTPA;
a scale removal enhancer;
a non-ionic surfactant; and
and said emulsion comprising:
water;
optionally, a hydrotrope;
optionally, 3-Methoxy-3-methyl-1-butanol (MMB) or isopropanol;
an alkanolamine;
a surfactant selected from a group consisting of: a sulfonate surfactant; an alcohol ethoxylate surfactant; and a combination thereof;
a non-ionic surfactant; and
an oil phase.

51. A method of removing barium sulfate scale from a surface contaminated with barium sulfate and at least one petroleum product, said method comprising:
providing an aqueous caustic composition comprising an emulsion for use in removing petroleum-contaminated barium sulfate scale from a surface contaminated with such, said composition comprising:
a chelating agent selected from the group consisting of: Li₅DTPA; Na₅DTPA; K₅DTPA; Cs₅DTPA; Na₄EDTA; K₄EDTA; TEAH₄DTPA; and TBAH₄DTPA;
optionally, a scale removal enhancer;
a non-ionic surfactant; and
and said emulsion comprising:
water;
optionally, a hydrotrope;
optionally, 3-Methoxy-3-methyl-1-butanol (MMB) or isopropanol;
an alkanolamine;
a surfactant selected from a group consisting of: a sulfonate surfactant; an alcohol ethoxylate surfactant; and a combination thereof;
a non-ionic surfactant; and
an oil phase;
exposing said surface to said aqueous caustic composition;
allowing sufficient time of exposure to remove said barium sulfate scale and said at least one petroleum product from said contaminated surface.

52. The method according to claim 51, wherein the scale removal enhancer is selected from the group consisting of: potassium carbonate; potassium formate; C₈COOH; C₈CO₃; and combinations thereof.
